(19) United States
(12) Patent Application Publication
(10) Pub. No.: US 2010/0199217 A1
(43) Pub. Date: Aug. 5, 2010

(54) MONITORING TERMINAL AND MONITORING METHOD PERFORMED IN THE SAME

(75) Inventors: Byung-soo GIM, Yongin-si (KR); Kwang-hyeon LEE, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, (KR)

(21) Appl. No.: 12/625,743

(22) Filed: Nov. 25, 2009

(30) Foreign Application Priority Data
Feb. 3, 2009 (KR) 10-2009-0008534

(51) Int. Cl. G06F 15/16; G06F 3/048

(52) U.S. Cl. 715/810; 709/217

(57) ABSTRACT

A monitoring terminal and a monitoring method performed in the monitoring terminal. The monitoring method includes receiving a monitoring set, including a plurality of pieces of monitoring information having a hierarchical relationship from the server, in a single transmission and performing monitoring according to the received monitoring set.

### CROSS-REFERENCE TO RELATED APPLICATIONS

This application claims priority to Korean Patent Application No. 10-2009-0008534, filed on Feb. 3, 2009, and all the benefits accruing therefrom under 35 U.S.C. §119, the disclosure of which is incorporated herein in its entirety by reference.

### BACKGROUND

1. Field

Provided is a monitoring terminal for remotely monitoring a user by having the user manipulate the monitoring terminal, and a monitoring method performed in the monitoring terminal.

2. Description of the Related Art

In order to monitor a patient remotely, a monitoring method using a number of transmissions between a hardware or computer-based server, and a hardware or computer terminal has been suggested. According to the monitoring method involving a number of transmissions between the server and the terminal, a plurality of questions regarding a state of the patient are stored in the server, where the plurality of questions have a hierarchical relationship. The patient may request for monitoring to the server by manipulating the terminal at anytime from anywhere, without having to visit a hospital, and the server may transmit a first question to the terminal in response to the request. The patient answers the first question by manipulating the terminal, and the terminal transmits the answer to the server. Then, the server transmits a second question based on the answer to the terminal, and then the patient answers the second question by manipulating the terminal and the terminal transmits the answer to the other question. As such, the patient is monitored via a number of transmissions between the server and the terminal.

However, the monitoring method consumes a large amount of time to complete the monitoring of the patient due to having frequent transmissions between the server and the terminal, and thus the monitoring method is not effectively performed. Moreover, the inefficiency of the monitoring method increases when data transmission speed in a network between the server and the terminal is slow.

### SUMMARY

Provided is a monitoring terminal for effectively monitoring a patient that is remote from a hospital.

Provided is a monitoring method for effectively monitoring a patient that is remote from a hospital.

Provided is a computer readable recording medium having recorded thereon a program for executing a monitoring method for effectively monitoring a patient in a remote place from a hospital.

Exemplary examples will be set forth in part in the description which follows and, in part, will be apparent from the description, or may be learned by practice of the illustrated examples.

Provided is a monitoring terminal includes a monitoring transceiver that receives a monitoring set, including a plurality of pieces of monitoring information having a hierarchical relationship, from a server in a single transmission, and a monitoring performer that performs monitoring according to the received monitoring set.

Provided is a monitoring method performed by a monitoring terminal connected to a server includes receiving a monitoring set, including a plurality of pieces of monitoring information having a hierarchical relationship, from the server in a single transmission, and performing monitoring according to the received monitoring set.

Provided is a computer readable recording medium has recorded thereon a program for executing a monitoring method which includes receiving a monitoring set, including a plurality of pieces of monitoring information having a hierarchical relationship, from the server in a single transmission, and performing monitoring according to the received monitoring set.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram describing an exemplary embodiment of hardware including a computer-based processing server and a monitoring terminal, according to the invention;

FIGS. 2A and 2B are exemplary embodiments of monitoring tables stored in the server of FIG. 1, according to the invention;

FIGS. 3A through 3E are diagrams of exemplary embodiment of monitoring information displayed by a display unit illustrated in FIG. 1, according to embodiments of the invention;

FIG. 4 is a flowchart illustrating an exemplary embodiment of a monitoring method, according to the invention; and

FIG. 5 is a flowchart illustrating an exemplary embodiment of operation 420 of FIG. 4, according to the invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art.

It will be understood that when an element is referred to as being “connected to” another element, the element can be directly connected to another element or intervening elements. In contrast, when an element is referred to as being “directly connected to” another element, there are no intervening elements present. Like numbers refer to like elements throughout. Connected also refers to physical and/or electrical connection. As used herein, the term “and/or” includes any and all combinations of one or more of the associated listed items.

It will be understood that, although the terms first, second, third, etc., may be used herein to describe various elements and/or components, these elements and/or components should not be limited by these terms. These terms are only used to distinguish one element or component from another element or component. Thus, a first element or component discussed below could be termed a second element or component without departing from the teachings of the invention.

Spatially relative terms, such as “upper,” “lower” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation or order depicted in the figures. For example, if a process is referred to in an opposite direction than shown, elements described as “upper” relative to other elements or features would then be oriented “lower” relative to the other elements or features. Thus, the exemplary term “upper” can encompass both an orientation of above and below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference will now be made in detail to embodiments, examples of which are illustrated in the accompanying drawings.

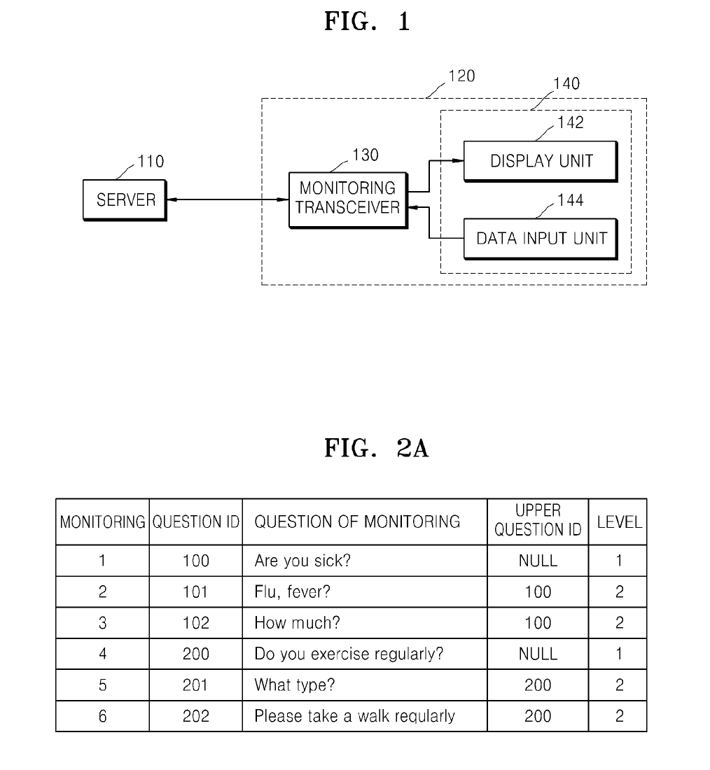

FIG. 1 is a block diagram describing an exemplary embodiment of hardware including a computer-based processor 110, hereinafter referred to as a “server,” and a monitoring terminal 120, such as a computer-based terminal, according to the invention.

The server 110 stores a monitoring set for monitoring the health of at least one user, such as a patient. The server 110 may store monitoring sets corresponding to each of a plurality of users, respectively.

In the specification, monitoring information means information indicating details of a question of monitoring. The monitoring information is classified according to each question. Here, the information indicating the details of a question may be information that does not require an answer, for example an advice such as ‘please jog at least 30 minutes a day’, information that requires a yes or no answer, information that requires one answer from among a plurality of examples, information that requires a plurality of answers from among a plurality of examples, or information that requires a detailed answer from a user without examples.

The monitoring set means information indicating a plurality of pieces of monitoring information having a hierarchical relationship and a pre-set monitoring order of the plurality of pieces of monitoring information. In an exemplary embodiment, the monitoring set may be text data such as eXtensible Markup Language (“XML”).

The contents of the monitoring set stored in the server 110 may be prepared or amended by a medical professional, such as a doctor, a nurse, or the like.

The monitoring terminal 120 is a computer-based or electronic terminal that may communicate with the server 110. In an exemplary embodiment, the monitoring terminal 120 may be a portable terminal. The monitoring terminal 120 may be located at a user site, which may be a remote site with respect to the server 110.

In the illustrated embodiment, a monitoring transceiver 130 receives a whole of the monitoring set from the server 110 in a single transmission, to reduce the number of transmissions between the server 110 and the monitoring terminal 120.

In more detail, the monitoring transceiver 130 downloads the plurality of pieces of monitoring information from the server 110. In one exemplary embodiment, the monitoring transceiver 130 downloads the monitoring set from the server 110 in a single transmission at regular or set time of a day, such as at every dawn, which reduces the number of transmissions between the server 110 and the monitoring terminal 120.

A monitoring performer 140 performs monitoring according to the monitoring set received by the monitoring transceiver 130. In more detail, the monitoring performer 140 performs monitoring according to the pre-set monitoring order and the hierarchical relationship of the plurality of pieces of monitoring information included in the monitoring set.

In more detail, the monitoring performer 140 may perform monitoring according to monitoring information of an upper level, and then may perform monitoring according to monitoring information of a lower level of the upper level. Also, the monitoring performer 140 performs monitoring on each of the plurality of pieces of monitor information according to the pre-set monitoring order, where former monitoring information is performed before latter monitoring information is performed.

The monitoring performer 140 may include a display unit 142 and a data input unit 144.

The display unit 142 may display and output each of the plurality of pieces of monitoring information to a user on one full screen at a time, according to the pre-set monitoring order of the plurality of pieces of monitoring information included in the monitoring set received by the monitoring transceiver 130. The display unit 142 may also be used to display outputted results of the monitoring, based on the monitoring set, to the user.

When monitoring information is displayed and outputted on the display unit 142, the data input unit 144 may receive from the user answer information corresponding to the displayed monitoring information. In the specification, answer information means information indicating an answer to the monitoring information, such as from the user.

The data input unit 144 may receive answer information from a user, by being actively manipulated by the user. In an exemplary embodiment, the data input unit 144 may be realized by at least one key or button, so that key manipulation is performed by the user pressing the at least one key or button with an instrument such as a finger, or by a touch pad so that key manipulation is performed by the user touching a screen with the instrument such as the finger. When the data input unit 144 is realized by a pressure sensitive key or button, the display unit 142 may be separated from the data input unit 144 and may be a device only having a display function and having no input function. When the data input unit 144 is realized by a touch pad, the data input unit 144 and the display unit 142 may be integrated with each other, such as to collectively form a single continuous indivisible member.

When the data input unit 144 receives answer information by being manipulated by the user, the user may input additional answer information indicating a detailed answer in regards to the monitoring information displayed on the display unit 142 to the data input unit 144. The user may input answer information indicating a “skip” to the data input unit 144 in order to not input an answer to the monitoring information, such as when the user is having difficulty answering, or wants to refuse to answer monitoring information in more detail.

In an exemplary embodiment, the data input unit 144 may receive answer information by measuring bio information of the user. In an exemplary embodiment, the bio information may include, but is not limited to, a bio signal such as an electrocardiogram signal, or blood information such as blood sugar.

The monitoring transceiver 130 transmits the answer information input by the user during the monitoring performed by the monitoring performer 140 to the server 110, and the server 110 stores the answer information received from the monitoring transceiver 130. The monitoring set stored in the server 110 may be updated according to the answer information. The answer information transmitted to the server 110 may be uploaded in a single transmission, or a plurality of transmissions.

The hardware components of the server 110, the monitoring terminal 120, the monitoring transceiver 130, the monitoring performer 140, the display unit 142 and/or the data input unit 144 may form a part of or be included in a system, where the system may include a graphical user interface, external hardware devices, a computer processor, a computer network server or other similar signal processing equipment.

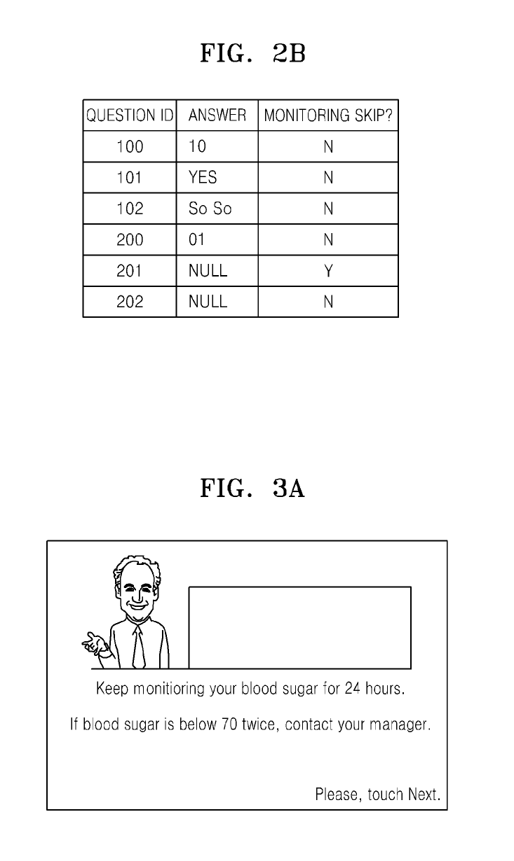

FIGS. 2A and 2B are exemplary embodiments of monitoring tables stored in the server 110 illustrated in FIG. 1, according to the invention.

FIG. 2A illustrates an exemplary embodiment of a monitoring table that is stored in the server 110, and expresses a monitoring set of the user. The monitoring table may be data prepared by a doctor for use in care of a user.

Referring to FIG. 2A, six pieces of monitoring information are included in the monitoring set, a monitoring order is pre-set for the six pieces of monitoring information, and a question identification (“ID”) is assigned to each of the six pieces of monitoring information. In FIG. 2A, question IDs 100 and 200 belong to level 1, e.g., a top or uppermost layer, and do not belong to any higher layer, as shown by the “NULL” in the “Upper Question ID” column. Question IDs 101 and 102 belong to level 2, e.g. a layer lower than level 1 and to the question ID 100, as shown in the “Upper Question ID” column. Question IDs 201 and 202 also belong to level 2, but to the question ID 200, as shown in the “Upper Question ID” column.

FIG. 2B illustrates an exemplary embodiment of answer information input by the user during the monitoring performed by the monitoring performer 140, for example, according to the monitoring set illustrated in FIG. 2A.

In more detail, the display unit 142 displays a phrase “Are you sick?” and answer examples include “Yes” and “No”. Then, the user may select an answer “Yes” by manipulating the data input unit 144 to input data indicating answer 10, which is a binary number for “Yes”.

Next, since the answer to question ID 100, which is an upper level question, is “Yes”, the display unit 142 displays a phrase “Flu, fever?”, and the user inputs data “Yes” by manipulating the data input unit 144.

Then, the display unit 142 displays a phrase “How much?”, and the user inputs data “So so” by manipulating the data input unit 144.

Then, the display unit 142 displays a phrase “Do you exercise regularly?” and answer examples include “Yes” and “No”. The user may select “No”, and input data indicating 01, which is a binary number for “No”, by manipulating the data input unit 144.

Next, the display unit 142 displays a phrase “What type?”, and since the user selected “No” for the phrase “Do you exercise regularly?” which is an upper level question, the user does not need to answer to the phrase “What type?”, and thus skips the phrase “What type?”. Accordingly, the data input unit 144 automatically receives data denoting skip.

Then, the display unit 142 recognizes that the answer to the upper level question “Do you exercise regularly?” is “No”, and displays a phrase “Please take a walk regularly”. The user takes such an advice and may not input data. However, if the user wants to input data, the user may input data denoting “Okay” by manipulating the data input unit 144.

The answer information illustrated in FIG. 2B, which is the answer information input by the user during the monitoring performed by the monitoring performer 140, is provided to the server 110, and the monitoring set of FIG. 2A stored in the server 110 may be updated according to the provided answer information from the user.

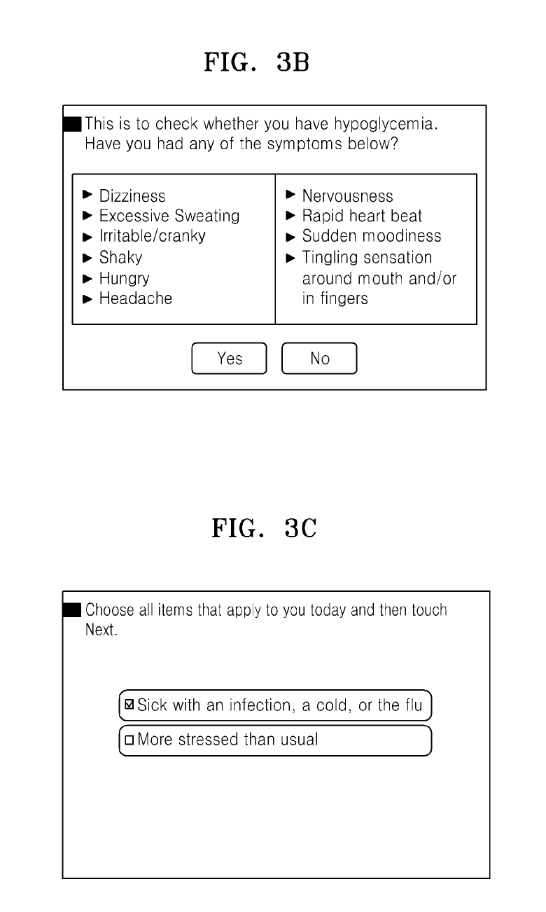

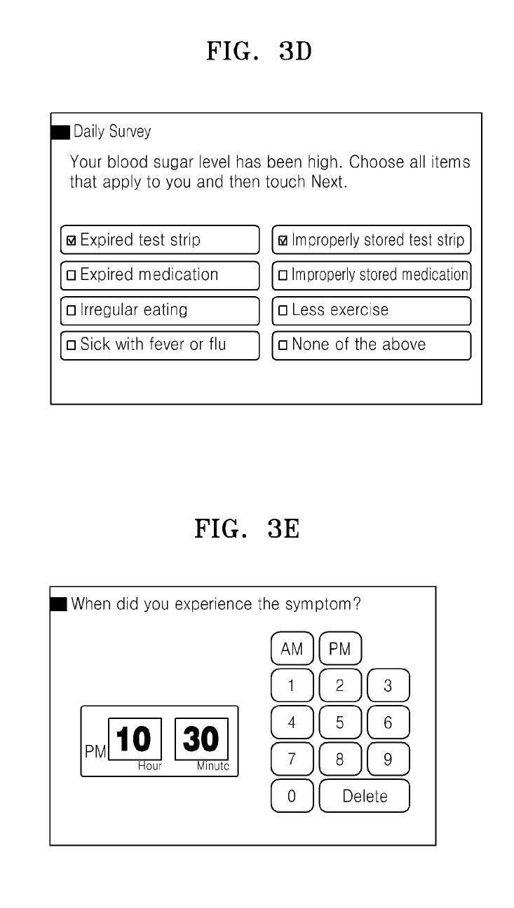

FIGS. 3A through 3E are diagrams of exemplary embodiments of monitoring information that may be displayed by the display unit 142 illustrated in FIG. 1, according to embodiments of the invention.

The monitoring information displayed by the display unit 142 may be a phrase stating an advice as illustrated in FIG. 3A, a phrase requesting to select “Yes” or “No” as illustrated in FIG. 3B, a phrase requesting a single selection from among a plurality of prompted choices as illustrated in FIG. 3C, a phrase requesting a plurality of selections from among a plurality of prompted choices as illustrated in FIG. 3D, or a phrase requesting a detailed answer from a user without providing prompted choices to the user as illustrated in FIG. 3E.

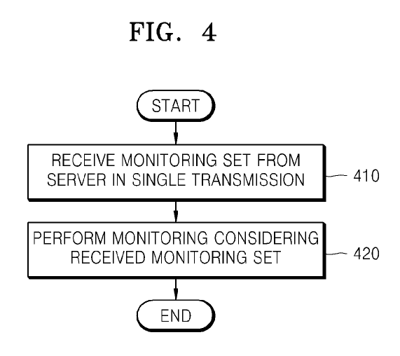

FIG. 4 is a flowchart illustrating an exemplary embodiment of a monitoring method according to the invention. The monitoring method will now be described with reference to FIGS. 1 and 4.

In operation 410, the monitoring terminal 120 receives a monitoring set from the server 110 in a single transmission, for example, only one download. Here, the monitoring set is information including a plurality of pieces of monitoring information having a hierarchical relationship.

In operation 420, the monitoring terminal 120 performs monitoring according to the monitoring set received in operation 410.

A portion of or an entire of operations 410 and 420 may be performed in a processing system, which may include a computer processor, computer network server and/or other signal processing equipment. Results of the receiving a monitoring set from the server 110 in a single transmission of operation 410 and/or performing the monitoring according to the monitoring set received in operation 410, may be outputted to a user, such as via a graphical user interface, or to an external (e.g., hardware) device such as a printer, a computer processor, computer network server or other signal processing equipment.

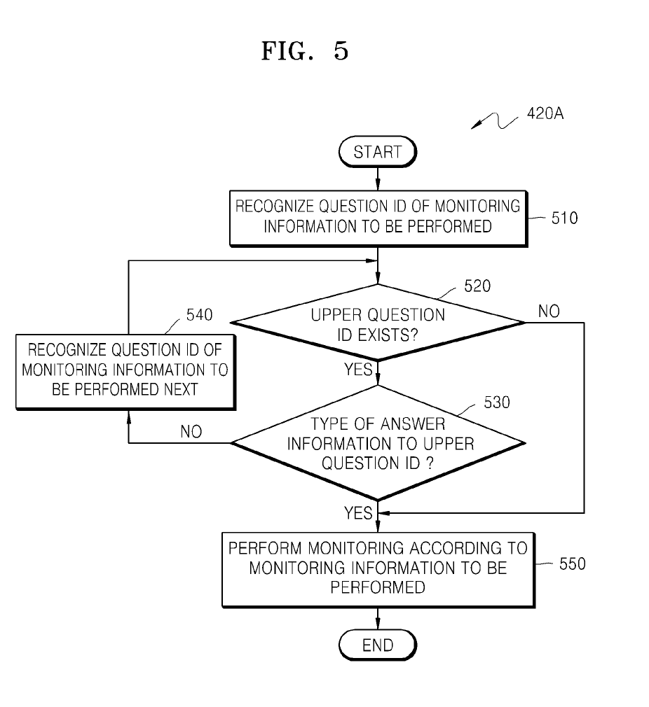

FIG. 5 is a flowchart illustrating an exemplary embodiment of operation 420 of FIG. 4, according to the invention. Referring to FIG. 5, in an operation 420A, the monitoring performer 140 of the monitoring terminal 120 performs monitoring according to one piece of monitoring information from among the plurality of pieces of monitoring information included in the monitoring set received in operation 410, while considering existence of upper level monitoring information of the one piece of monitoring information, and a type of answer information according to the upper level monitoring information.

The monitoring terminal 120 temporarily stores the monitoring set received in the one transmission download in operation 410, and the display unit 142 displays one piece of monitoring information that is to be currently performed in the monitoring process. The monitoring terminal 120 recognizes a question ID of the one piece of monitoring information that is to be currently performed in the monitoring process, by analyzing the temporarily stored monitoring set, in operation 510.

The monitoring terminal 120 stores question IDs of monitoring information displayed on the display unit 142 from among the plurality of pieces of monitoring information included in the monitoring set received in operation 410, and if answer information to the monitoring information has been input to the monitoring terminal 120, the monitoring terminal 120 also stores the answer information.

The monitoring terminal 120 determines whether an upper level question ID of a question ID recognized most recently by the monitoring terminal 120 exists from among the question IDs of the monitoring information displayed on the display unit 142 stored in the monitoring terminal 120, in operation 520. The most recently recognized question ID in FIG. 5 with respect to operation 530, for example, is the question ID recognized in operation 510 or the question ID recognized in operation 540.

When it is determined that the upper level question ID exists in operation 520, the monitoring terminal 120 determines whether the type of answer information to the upper level question ID determined to exist in operation 520 is YES or NO, from among answer information stored in the monitoring terminal 120 in operation 530.

When it is determined that the type of the answer information is NO in operation 530, the monitoring terminal 120 recognizes the question ID of monitor information in an order right after the question ID recognized in operation 510, in operation 540, and operation 520 is performed again.

When it is determined that the upper level question ID does not exist in operation 520, or that the type of the answer information is YES in operation 530, the monitoring terminal 120 performs monitoring according to monitoring information of the question ID most recently recognized by the monitoring terminal 120 in operation 550.

A portion of or an entire of operations 510 to 550 may be performed in a processing system, which may include a computer processor, computer network server and/or other signal processing equipment. Results of the recognizing a question ID of the one piece of monitoring information that is to be currently performed in the monitoring process of operation 510, determining whether an upper level question ID of a question ID recognized most recently by the monitoring terminal 120 exists in operation 520, determining whether the type of answer information to the upper level question ID determined to exist in operation 520 is YES or NO of operation 530, recognizing the question ID of monitor information in an order right after the question ID recognized in operation 510 of operation 540 and/or the performing the monitoring according to monitoring information of the question ID most recently recognized by the monitoring terminal 120 of operation 550, may be outputted to a user, such as via a graphical user interface, or to an external (e.g., hardware) device such as a printer, a computer processor, computer

A program for executing the monitoring method in a computer processor may be stored in a computer readable recording medium.

Examples of the computer readable recording medium include, but are not limited to, magnetic storage media (e.g., read only memories (“ROMs”), floppy disks, hard disks, etc.), and optical recording media (e.g., compact disc (“CD”)-ROMs, or digital versatile discs (“DVDs”)).

It should be understood that the exemplary embodiments described herein should be considered in a descriptive sense only and not for purposes of limitation. Descriptions of features within each embodiment should typically be considered as available for other similar features or aspects in other embodiments.

What is claimed is:

1. A monitoring terminal comprising:
a monitoring transceiver which receives a monitoring set, including a plurality of pieces of monitoring information having a hierarchical relationship, from a computer-based server in a single transmission; and
a monitoring performer which performs monitoring according to the received monitoring set.

2. The monitoring terminal of claim 1, wherein the monitoring performer performs the monitoring according to a pre-set monitoring order and the hierarchical relationship of the plurality of pieces of the monitoring information.

3. The monitoring terminal of claim 1, wherein the monitoring performer performs the monitoring according to one piece of monitoring information from among the plurality of pieces of monitoring information, while considering existence of upper level monitoring information of the one piece of monitoring information and a type of answer information according to the upper level monitoring information.

4. The monitoring terminal of claim 1, wherein the monitoring performer comprises:
a display unit which displays each of the plurality of pieces of monitoring information one screen at a time, according to a pre-set monitoring order of the plurality of pieces of monitoring information; and
a data input unit which receives answer information corresponding to displayed monitoring information.

5. The monitoring terminal of claim 4, wherein the data input unit receives the answer information by the data input unit being manipulated by a user.

6. The monitoring terminal of claim 4, wherein the data input unit receives the answer information by measuring bio information of a user.

7. The monitoring terminal of claim 1, wherein the monitoring performer transmits answer information corresponding to the monitoring to the server, and the server stores the answer information received from the monitoring performer.

8. The monitoring terminal of claim 7, wherein the monitoring set stored in the server is updated according to the answer information received from the monitoring performer.

9. The monitoring terminal of claim 1, wherein the monitoring set is text data.

10. A monitoring method performed by a monitoring terminal connected to a server, the server comprising a computer processor and the monitoring method comprising:
receiving a monitoring set, including a plurality of pieces of monitoring information having a hierarchical relationship, from the server in a single transmission; and
performing monitoring according to the received monitoring set.

11. The monitoring method of claim 10, wherein in the performing of the monitoring, the monitoring is performed according to a pre-set monitoring order and the hierarchical relationship of the plurality of pieces of monitoring information.

12. The monitoring method of claim 10, wherein in the performing of the monitoring, monitoring according to one piece of monitoring information from among the plurality of pieces of monitoring information is performed, while considering existence of upper level monitoring information of the one piece of monitoring information and a type of answer information according to the upper level monitoring information.

13. The monitoring method of claim 10, wherein the performing of the monitoring comprises:
displaying one piece of monitoring information selected based on a pre-set monitoring order of the plurality of pieces of monitoring information;
receiving answer information corresponding to the displayed one piece of monitoring information; and
determining whether the displaying of the one piece of monitoring information is performed for each of the plurality of pieces of monitoring information, and selectively performing the displaying of the one piece of monitoring information based on the result of the determination.

14. The monitoring method of claim 13, wherein, in the receiving of the answer information, the answer information is received by being input by a user.

15. The monitoring method of claim 13, wherein, in the receiving of the answer information, the answer information is received by measuring bio information of a user.

16. The monitoring method of claim 10, wherein in the performing of the monitoring, answer information about the monitoring is transmitted to the server and the server stores the received answer information.

17. The monitoring method of claim 16, wherein the monitoring set stored in the server is updated according to the received answer information.

18. The monitoring method of claim 10, wherein the monitoring set is text data.

19. A computer readable recording medium having recorded thereon a program which executes a monitoring method performed by a monitoring terminal connected to a server, the server comprising a computer processor and the monitoring method comprising:
receiving a monitoring set, including a plurality of pieces of monitoring information having a hierarchical relationship, from the server in a single transmission; and
performing monitoring according to the received monitoring set.
